(19) United States
(12) Patent Application Publication
(10) Pub. No.: US 2008/0012789 A1
(43) Pub. Date: Jan. 17, 2008

(54) MULTIMEDIA DISPLAY SYSTEM, MULTIMEDIA DISPLAY APPARATUS AND METHOD THEREOF

(75) Inventor: Yu-Chieh Chou, Hsinchu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MEDIATEK INC., Hsin-Chu City (TW)

(21) Appl. No.: 11/458,026

(22) Filed: Jul. 17, 2006

(51) Int. Cl. G09G 5/00

(52) U.S. Cl. 345/1.1

(57) ABSTRACT

A multimedia display system, a multimedia display apparatus and a method thereof are provided. The multimedia display system comprises a demultiplexer, the multimedia display apparatus, and a mixer. The multimedia display apparatus comprises a first decoder, a second decoder, and an interface. The demultiplexer demultiplexes a first signal to generate a first source and demultiplexes a second signal to generate a second source. The first decoder decodes the first source in a first type. The second decoder decodes the second source in a second type. The interface simultaneously outputs the decoded first source in the first type and the decoded second source in the second type.

### CROSS-REFERENCES TO RELATED APPLICATIONS

Not applicable.

### BACKGROUND OF THE INVENTION

1. Field of the Invention

The present invention relates to a multimedia display system, a multimedia display apparatus and a method thereof. In particular, the present invention relates to a multimedia display system, a multimedia display apparatus and a method for displaying different sources simultaneously.

2. Descriptions of the Related Art

Multimedia data may be carried on a digital television (DTV) channel, a VCD, a DVD, a HD-DVD, a Blu-ray disk, or the like. When a multimedia data is retrieved through, for example, a channel of digital video broadcasting (DVB), it is transmitted in transport streams (TS) which comprise a program association table (PAT) and a program map table (PMT). According to the PAT and PMT, multimedia information, such as audio data, video data, and subtitle data can be obtained.

FIG. 1 shows an example of a DVB of the prior art in which the audio data is outputted to a pair of speakers 101 for a viewer to hear the sound of the multimedia. The video data is outputted to a screen 102 for the viewer to watch the dynamic images of the multimedia. The subtitle is an encoded extra bitstream, which can be decoded and displayed independently from the audio data and the video data. The subtitle has additional information, e.g. strolling texts 103. Other multimedia carriers also have similar data, for example, a sub-picture for DVD, and a closed-caption for ATSC digital TV.

Although most of the multimedia carriers are able to simultaneously carry data in different formats, such as the aforementioned audio data, video data, and subtitle data, these data come from the same multimedia. In other words, a multimedia display apparatus of the prior art fails to simultaneously display different sources of different types when the viewer needs information from different sources at the same time. Therefore, a solution that broadcasts different sources simultaneously is required in the industrial field.

### SUMMARY OF THE INVENTION

An objective of this invention is to provide a multimedia display apparatus. The multimedia display apparatus comprises a first decoder, a second decoder, and an interface. The first decoder decodes a first source in a first type, wherein the first source is a multimedia source. The second decoder decodes a second source in a second type which is different from the first type. The interface simultaneously outputs the first decoded source in the first type and the second decoded source in the second type.

Another objective of this invention is to provide a multimedia display method. The method comprises the following steps: decoding a first source in a first type, wherein the first source is a multimedia source; decoding a second source in a second type; and outputting the first decoded source in the first type and the second decoded source in the second type simultaneously. The first type and the second type are different.

Another objective of this invention is to provide a multimedia display apparatus. The multimedia display apparatus comprises a first decoder, a second decoder, and an interface. The first decoder decodes a first source in a type, wherein the first source is a multimedia source. The second decoder decodes a second source in the type. The interface outputs the first decoded source and the second decoded source simultaneously. The type is one of an audio format, a still image format, a subtitle, and a texture format.

Another objective of this invention is to provide a multimedia display method. The method comprises the following steps: decoding a first source in a type, wherein the first source is a multimedia source; decoding a second source in the type; and outputting the first decoded source and the second decoded source simultaneously. The type is one of an audio format, a still image format, a subtitle, and a texture format.

Another objective of this invention is to provide a multimedia display system. The multimedia display system comprises a demultiplexer, a first codec, a second codec, and a mixer. The demultiplexer demultiplexes a first signal to generate a first source and demultiplexes a second signal to generate a second source. The first codec decodes the first source in a first type. The second codec decodes the second source in a second type. The mixer mixes the first decoded source and the second decoded source. The first source is a multimedia source. The first type and the second type are different.

Yet a further objective of this invention is to provide a multimedia display apparatus. The multimedia display apparatus comprises: means for decoding a first source in a first type, wherein the first source is a multimedia source; means for decoding a second source in a second type; and means for outputting the first decoded source in the first type and the second decoded source in the second type simultaneously. The first type and the second type are different.

Yet a further objective of this invention is to provide a multimedia display apparatus. The multimedia display apparatus comprises: means for decoding a first source in a type, wherein the first source is a multimedia source; means for decoding a second source in the type; and means for outputting the first decoded source and the second decoded source simultaneously. The type is one of an audio format, a still image format, a subtitle, and a texture format.

The present invention has the advantage of obtaining information from different sources with only one multimedia display at the same time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional DVB system;

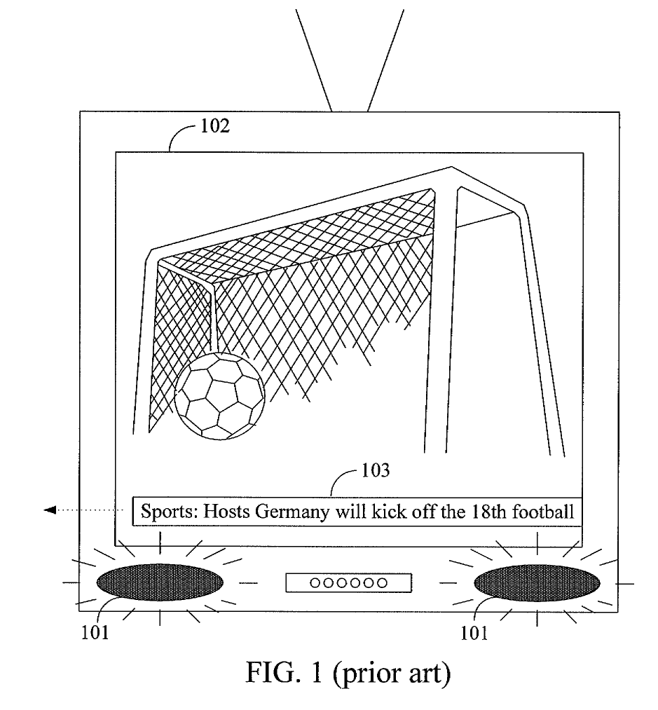

FIG. 2 illustrates a first embodiment in accordance with the present invention;

FIG. 3 is a flow chart of a second embodiment in accordance with the present invention;

FIG. 4 illustrates a third embodiment in accordance with the present invention; and

FIG. 5 is a flow chart of a fourth embodiment in accordance with the present invention.

### DESCRIPTION OF THE PREFERRED EMBODIMENT

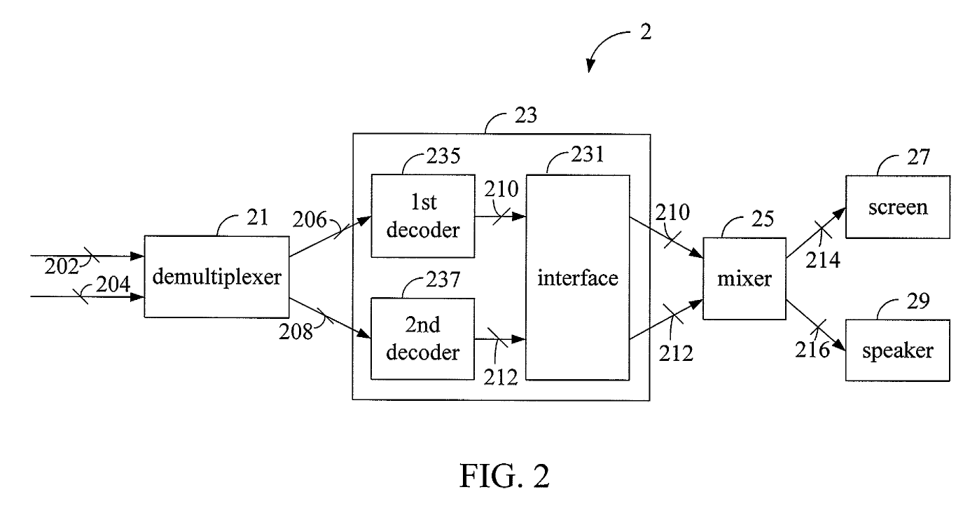

FIG. 2 shows a first embodiment of the present invention, which is a multimedia display system 2. The multimedia display system 2 comprises a demultiplexer 21, a multimedia display apparatus 23, a mixer 25, a screen 27, and a speaker 29. The multimedia display apparatus 23 comprises a first codec, a second codec, and an interface 231. In this embodiment, the first codec and second codec are a first decoder 235 and a second decoder 237, respectively.

The demultiplexer 21 demultiplexes a first signal 202 to generate a first source 206 and demultiplexes a second signal 204 to generate a second source 208 in response to viewer's inputs. Both the first signal 202 and the second signal 204 are, but unnecessarily limited to, DTV signals that come from two different DTV channels. Both the first signal 202 and the second signal 204 comprise packetized elementary streams (PESs). The first decoder 235 decodes the first source 206 in a first type, and the second decoder 237 decodes the second source 208 in a second type, wherein the first type and the second type are different. In particular, the first type and the second type may be an audio format, a video format, a still image format, or a texture format retrieved from the PESs. The texture format is a general concept herein which may comprise information of a subtitle, a teletext, a closed-caption, or even a strolling text.

The first type and the second type are determined by the first decoder 235 and the second decoder 237. In this embodiment, the first decoder 235 is a video decoder so that the first type is in a video format, while the second decoder 237 is an audio decoder so that the second type is in an audio format. That is, the first decoder 235 outputs a video signal 210 which carries the video PES of the first signal 202, and the second decoder 237 outputs an audio signal 212 which carries the audio PES of the second signal 204. The interface 231 outputs the video signal 210 and the audio signal 212 to the mixer 25 simultaneously. More specifically, the interface 231 may comprise two sub-interfaces which output the video signal 210 and the audio signal 212, respectively The mixer 25 mixes the video signal 210 and the audio signal 212, i.e., mixes the first source 206 and the second source 208 together. The mixer 25 then transmits a video part 214, coming from the video signal 210, to the screen 27 and an audio part 216, coming from the audio signal 212, to the speaker 29. The viewer may, hence, watch the dynamic images of the first signal 202 on the screen 27 and also listen to the audio of the second signal 204 from the speaker 29 without switching channels. The viewer is thus able to obtain two pieces of information from different sources at the same time.

Rather than coming from DTV channels, the first and second sources 206, 208 may come from any multimedia source such as a VCD, a DVD, a HD-DVD, a Blu-ray disc, etc.

Rather than being decoded in different types, the first and second sources 206, 208 may be decoded in the same type, e.g. in the video type. In these cases, the mixer 25 mixes the signal 210, 212 into one video or still image and outputs the video or still image to the screen 27. The screen 27 displays the video or still image that carries two pieces of information from different sources 206, 208 at the same time.

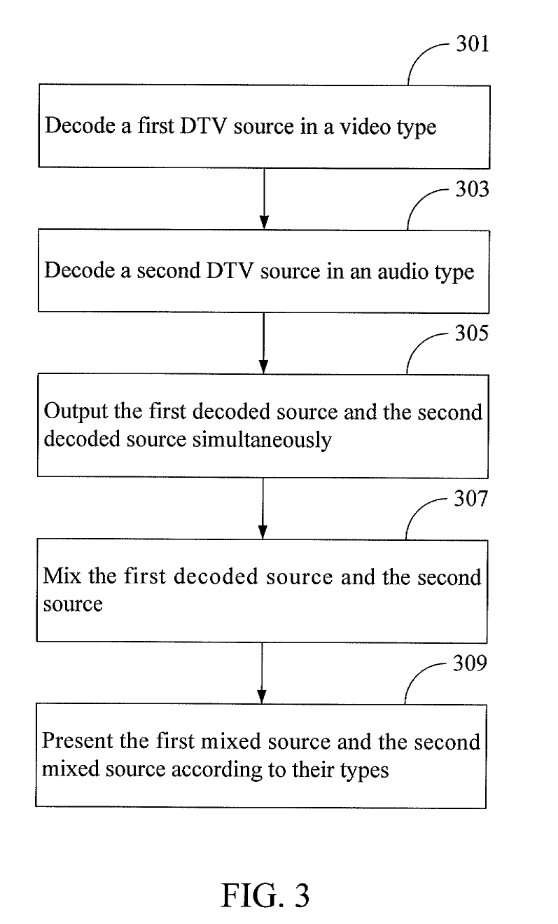

A second embodiment of the present invention is a multimedia display method. The method is adapted for a multimedia display apparatus, as noted in the first embodiment. FIG. 3 shows a flow chart of this method. In step 301, decoding a first DTV source in a video type is executed. In step 303, decoding a second DTV source in an audio type is then executed. In step 305, outputting the first decoded source and the second decoded source simultaneously is executed. Step 307 is then executed to mix the first decoded source and the second decoded source. Finally, presenting the first mixed source and the second mixed source according to their types is executed in step 309. A viewer is able to obtain two pieces of information from different sources at the same time without switching channels.

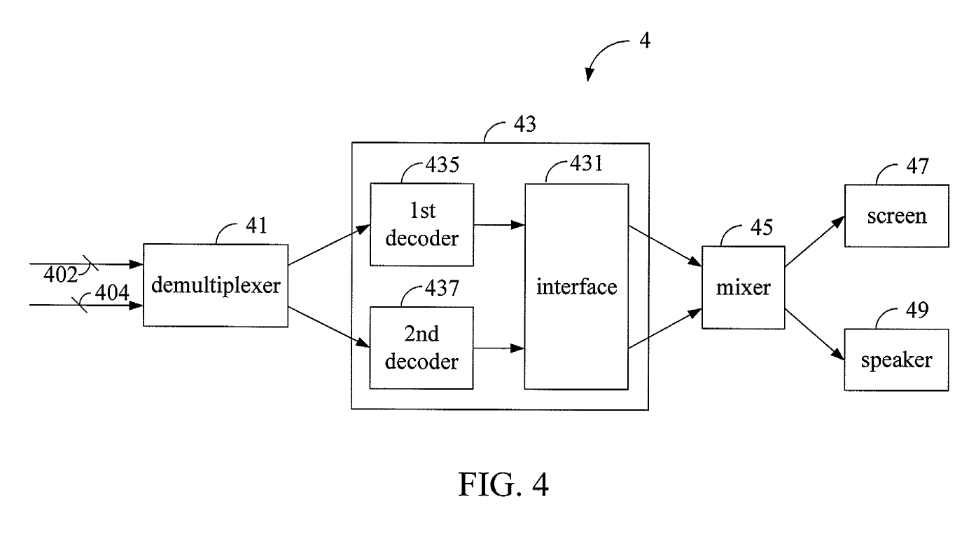

In addition to the steps shown in FIG. 3, the second embodiment is able to perform all of the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein. FIG. 4 shows a third embodiment of the present invention, which is a multimedia display system 4. The multimedia display system 4 comprises a demultiplexer 41, a multimedia display apparatus 43, a mixer 45, a screen 47, and a speaker 49. The multimedia display apparatus 43 comprises a first decoder 435, a second decoder 437, and an interface 431. The demultiplexer 41, the mixer 45, the screen 47, the speaker 49, the first decoder 435, the second decoder 437, and the interface 431 are similar to the corresponding element of the first embodiment, respectively.

In contrast to the first embodiment, the demultiplexer 41 demultiplexes a first signal 402 coming from a DTV channel and demultiplexes a second signal 404 coming from a storage device which stores multimedia data, such as an optical storage medium. In the third embodiment, the optical storage medium is a DVD. The second decoder 437 decodes the second source (DVD) in a second type different from a first type of the first source after decoding. For example, the first type is video and the second type is audio. Similarly, the viewer is able to obtain two pieces of information from different sources at the same time.

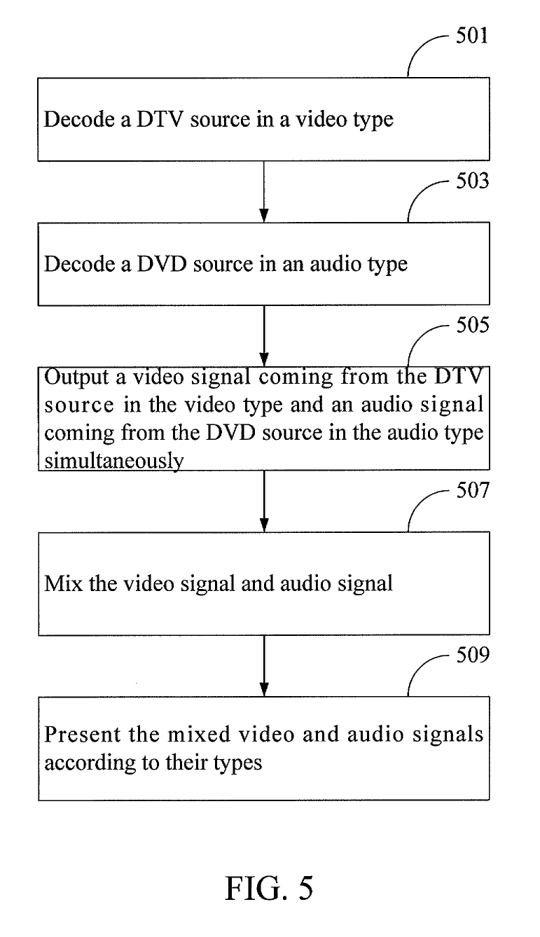

A fourth embodiment of the present invention is a multimedia display method. The method is adapted for a multimedia display apparatus, as noted in the third embodiment. FIG. 5 shows a flow chart of this method. In step 501, decoding a DTV source in a video type is executed. In step 503, decoding a DVD source in an audio type is then executed. In step 505, outputting a video signal coming from the DTV source in the video type and an audio signal coming from the DVD source in the audio type simultaneously is executed. Step 507 is then executed to mix the video signal and audio signal. Finally, presenting the mixed video and audio signals according to their types is executed in step 509. A viewer is able to obtain two pieces of information from different sources at the same time without switching channels.

In addition to the steps shown in FIG. 5, the fourth embodiment is able to perform all of the operations or functions recited in the third embodiment. Those skilled in the art can straightforwardly realize how the fourth embodiment performs these operations and functions based on the above descriptions of the third embodiment. Therefore, the descriptions for these operations and functions are redundant and not repeated herein.

Though the aforementioned embodiments are illustrated based on two sources, the number of sources is not a limitation of the present invention.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A multimedia display apparatus, comprising:
a first decoder for decoding a first source in a first type, the first source being a multimedia source;
a second decoder for decoding a second source in a second type; and
an interface for outputting the decoded first source in the first type and the decoded second source in the second type simultaneously;
wherein the first type and the second type are different.

2. The multimedia display apparatus as claimed in claim 1, wherein the first source comes from a TV channel.

3. The multimedia display apparatus as claimed in claim 1, wherein the first type is one of an audio format, a video format, a still image format, and a texture format.

4. The multimedia display apparatus as claimed in claim 1, wherein the first type is one of a subtitle, a teletext, and a closed-caption.

5. The multimedia display apparatus as claimed in claim 1, wherein the second source comes from a storage device.

6. The multimedia display apparatus as claimed in claim 5, wherein the storage device is an optical storage medium.

7. The multimedia display apparatus as claimed in claim 6, wherein the optical storage medium is a DVD.

8. The multimedia display apparatus as claimed in claim 1, wherein the second source comes from a TV channel.

9. The multimedia display apparatus as claimed in claim 1, wherein the second type is one of an audio format, a video format, a still image format, and a texture format.

10. The multimedia display apparatus as claimed in claim 1, wherein the second type is one of a subtitle, a teletext, and a closed-caption.

11. A multimedia display method, comprising:
decoding a first source in a first type, the first source being a multimedia source;
decoding a second source in a second type; and
outputting the first decoded source in the first type and the second decoded source in the second type simultaneously;
wherein the first type and the second type are different.

12. The multimedia display method as claimed in claim 11, wherein the first source comes from a TV channel.

13. The multimedia display method as claimed in claim 11, wherein the first type is one of an audio format, a video format, a still image format, and a texture format.

14. The multimedia display method as claimed in claim 11, wherein the first type is one of a subtitle, a teletext, and a closed-caption.

15. The multimedia display method as claimed in claim 11, wherein the second source comes from a storage device.

16. The multimedia display method as claimed in claim 15, wherein the storage device is an optical storage medium.

17. The multimedia display method as claimed in claim 16, wherein the optical storage medium is a DVD.

18. The multimedia display method as claimed in claim 11, wherein the second source comes from a TV channel.

19. The multimedia display method as claimed in claim 11, wherein the second type is one of an audio format, a video format, a still image format, and a texture format.

20. The multimedia display method as claimed in claim 11, wherein the second type is one of a subtitle, a teletext, and a closed-caption.

21. A multimedia display apparatus, comprising:
a first decoder for decoding a first source in a type, the first source being a multimedia source;
a second decoder for decoding a second source in the type; and
an interface for outputting the first decoded source and the second decoded source simultaneously;
wherein the type is one of an audio format, a still image format, a subtitle, and a texture format.

22. A multimedia display method, comprising:
decoding a first source in a type, the first source being a multimedia source;
decoding a second source in the type; and
outputting the first decoded source and the second decoded source simultaneously;
wherein the type is one of an audio format, a still image format, a subtitle, and a texture format.

23. A multimedia display system, comprising:
a demultiplexer for demultiplexing a first signal to generate a first source and for demultiplexing a second signal to generate a second source;
a first codec for decoding the first source in a first type;
an second codec for decoding the second source in a second type; and
a mixer for mixing the first decoded source and the second decoded source;
wherein the first source is a multimedia source, and the first type and the second type are different.

24. A multimedia display apparatus, comprising:
means for decoding a first source in a first type, the first source being a multimedia source;
means for decoding a second source in a second type; and
means for outputting the first decoded source in the first type and the second decoded source in the second type simultaneously;
wherein the first type and the second type are different.

25. A multimedia display apparatus, comprising:
means for decoding a first source in a type, the first source being a multimedia source;
means for decoding a second source in the type; and
means for outputting the first decoded source and the second decoded source simultaneously;
wherein the type is one of an audio format, a still image format, a subtitle, and a texture format.
